(19) United States
(12) Patent Application Publication
(10) Pub. No.: US 2019/0047312 A1
(43) Pub. Date: Feb. 14, 2019

(54) RUBBER BLANKET FOR A PRINTING CYLINDER OF A PRINTING MACHINE

(71) Applicant: TRELLEBORG COATED SYSTEMS ITALY S.P.A., Milano (IT)

(72) Inventors: Denis HERTZOG, Berrwiller (FR); Sophie HARAUX, Aspach-Michelbach (FR); Fabio TOMBOLATO, Pove del Grappa (Vicenza) (FR)

(73) Assignee: TRELLEBORG COATED SYSTEMS ITALY S.P.A., Milano (IT)

(21) Appl. No.: 16/078,566

(22) PCT Filed: Feb. 17, 2017
(86) PCT No.: PCT/EP2017/053599

§ 371 Date: Aug. 21, 2018

(30) Foreign Application Priority Data
Feb. 22, 2016 (IT) 102016000018147

(51) Int. Cl. B41N 10/04; B41F 13/193

(52) U.S. Cl. CPC B41N 10/04; B41N 2210/14; B41N 2210/04; B41F 13/193

(57) ABSTRACT

A rubber blanket for a printing cylinder of a printing machine, comprising at least an upper printing layer made of compact elastomeric material, at least a lower layer having a contact surface in contact with the printing cylinder, and at least one fabric reinforcement layer interposed between the upper layer and the lower layer, the lower layer being made of expanded elastomeric material.

### CROSS-REFERENCE TO RELATED APPLICATIONS

This is a U.S. national phase application under 35 U.S.C. §371 of International Patent Application No. PCT/EP2017/053599, filed Feb. 17, 2017, and claims benefit of priority to Italian Patent Application No. 102016000018147, filed Feb. 22, 2016. The entire contents of these applications are hereby incorporated by reference.

### FIELD OF TECHNOLOGY

The present invention relates to rubber blankets for printing cylinders of offset printing machines, especially, but not exclusively, of the sheet-fed offset type. As is well known to the person skilled in the art, in these printing machines, mounted on a printing cylinder made of metal and rotating about its own axis, there is a multilayer product, known in the industry as a printing rubber blanket, which covers the outer surface of the printing cylinder.

### BACKGROUND

A printing rubber blanket has an upper elastomeric layer that acts as a printing surface, a compressible intermediate layer, and one or more lower reinforcement layers made of fabric, the last of which is applied on the surface of the printing cylinder.

This type of printing rubber blanket exhibits some drawbacks.

Firstly, in order to be correctly fixed to the cylinder, the last lower layer requires the application of a special adhesive layer, which, though on the one hand it achieves its purpose, on the other hand it complicates the replacement of the rubber blanket, imposing machine downtimes, even long ones, with consequent negative repercussions on productivity.

Secondly, a rubber blanket with such a structure does not easily lend itself to grinding to bring the overall thickness to the desired value.

In particular, in order to bring the overall thickness of the rubber blanket to the desired value, it is sometimes necessary to grind the upper layer, which, however, for the purpose of optimizing printing quality has a mirror-like surface finish which must be restored.

EP2502753 discloses a printing blanket made of layers detachably connected to each other.

Therefore, the task of the present invention is to provide a printing rubber blanket capable of overcoming the drawbacks found in the prior art.

### SUMMARY

In particular, one object of the present invention is to provide a rubber blanket for a printing cylinder having a structure that makes it adaptable in a versatile manner to production in various thicknesses and to a simplified mounting on and removal from the printing cylinder.

Another object of the present invention is to provide a rubber blanket for a printing cylinder which offers the desired mechanical properties with a substantial reduction in costs.

These objects are achieved, according to the present invention, by virtue of a rubber blanket for a printing cylinder of a printing machine, comprising at least an upper printing layer made of compact elastomeric material, at least a lower layer having a contact surface in contact with said printing cylinder, and at least one fabric reinforcement layer interposed between the upper layer and the lower layer, characterized in that said lower layer is made of expanded elastomeric material. Advantageously, said expanded elastomeric material has a porosity adapted so as to impart to the lower layer a susceptibility to abrasion for grinding the thickness of said lower layer.

Advantageously, said expanded elastomeric material also has a porosity adapted so as to impart to the lower layer a susceptibility to direct adhesion to said cylinder without the addition of another adhesive layer.

Said layers of said rubber blanket are undetachably connected to each other.

In a preferred embodiment of the invention, said expanded elastomeric material is a thermoplastic elastomer.

In a preferred embodiment of the invention, said thermoplastic elastomer comprises a thermoplastic polyurethane.

In a preferred embodiment of the invention said expanded elastomeric material is a vulcanized thermoset elastomer.

In a preferred embodiment of the invention, said vulcanized thermoset elastomer comprises at least one selected from among PU, NBR, EPDM, SBR and EPM. These and other aspects will become more evident from the description that follows of preferred embodiments of the invention, which must be considered as non-limiting examples.

### BRIEF DESCRIPTIONS OF THE DRAWINGS

The description makes reference to the appended drawings, in which:

FIG. 1 shows a cross-section of a printing rubber blanket according to a first preferred embodiment of the present invention;

FIG. 2 shows a cross-section of a printing rubber blanket according to a second preferred embodiment of the present invention;

FIG. 3 shows a cross-section of a printing rubber blanket according to a third preferred embodiment of the present invention;

FIG. 4 shows the rubber blanket of FIG. 3 mounted on a printing cylinder.

### DETAILED DESCRIPTION

The printing rubber blanket for a printing cylinder of a printing machine is generally indicated by the reference number 1.

The printing rubber blanket 1 has a multilayer structure comprising at least a lower layer 2 having a contact surface 2a in contact with the printing cylinder 8, at least an upper printing layer 3, 3′, and at least an intermediate fabric reinforcement layer 4 interposed between the upper layer 3, 3′ and the lower layer 2.

Advantageously, the lower layer 2 is made of expanded elastomeric material.

Advantageously, the expanded elastomeric material has a porosity adapted so as to impart to the lower layer 2a susceptibility to abrasion for grinding the thickness of the lower layer 2.

Advantageously, moreover, the expanded elastomeric material has a porosity adapted so as to impart to the lower layer 2a susceptibility to direct adhesion to the printing cylinder without the addition of another adhesive layer.

The elastomeric material is expanded with microspheres or expanding agents such as azodicarbonamide.

The expanded elastomeric material can be a thermoplastic elastomer or a thermoset elastomer.

The expanded elastomeric material, if thermoplastic, preferably comprises a thermoplastic polyurethane.

The expanded elastomeric material, if thermoset, comprises a vulcanized rubber comprising at least one polymer selected from among PU (polyurethane rubber), NBR (nitrile butadiene rubber), EPDM (ethylene propylene diene monomer rubber), SBR (styrene butadiene rubber) and EPM (ethylene propylene rubber). Preferably, the compact elastomeric material forming the upper layer 3, 3′ can also be, in general, a thermoplastic or thermoset elastomer.

Preferably, the upper layer 3, 3′ is produced by deposition of a thermoplastic polyurethane elastomer by casting so as to impart adequate smoothness and a mirror finish to the printing surface 3a.

The fabric reinforcement layer 4 is preferably made of cotton fibres or a blend of cotton and polyester fibres.

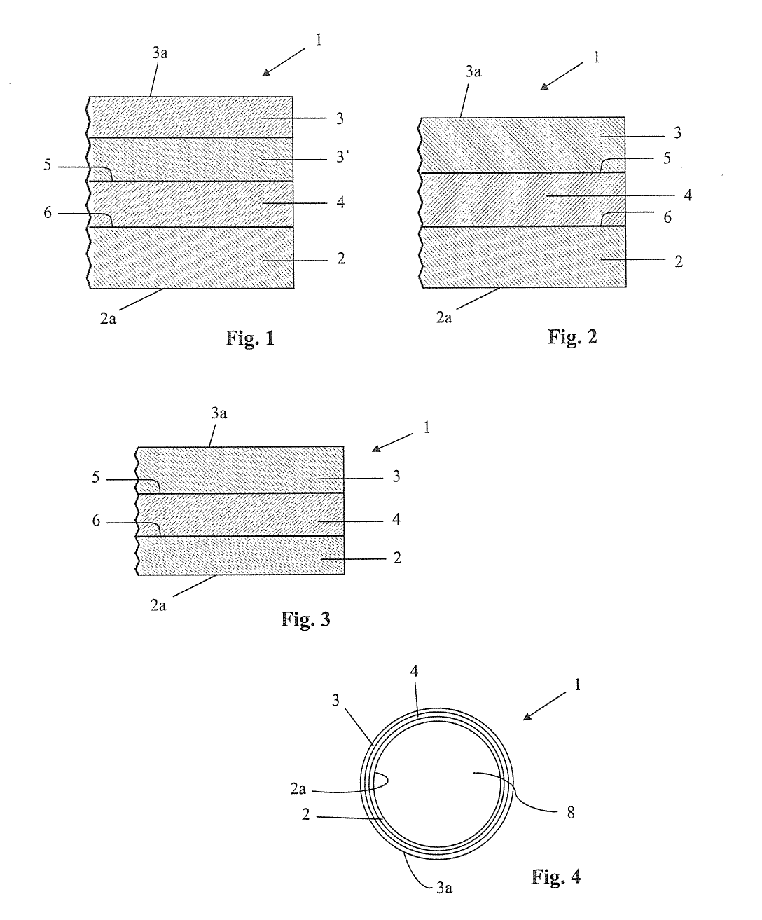

With reference to FIG. 1, the rubber blanket 1 consists of a series of two upper layers 3, 3′ each having a uniform thickness of 0.35 mm, a lower layer 2 having a uniform thickness of 0.50 mm, an intermediate fabric reinforcement layer 4 having a uniform thickness of 0.45 mm, a first adhesive layer 5 for fixing the intermediate layer 4 to the upper layer 3, and a second adhesive layer 6 for fixing the intermediate layer 4 to the lower layer 2.

With reference to FIG. 2, the rubber blanket 1 consists of an upper layer 3 having a uniform thickness of 0.35 mm, a lower layer 2 having a uniform thickness of 0.50 mm, an intermediate fabric reinforcement layer 4 having a uniform thickness of 0.45 mm, a first adhesive layer 5 for fixing the intermediate layer 4 to the upper layer 3, and a second adhesive layer 6 for fixing the intermediate layer 4 to the lower layer 2.

With reference to FIG. 3, the rubber blanket 1 consists of an upper layer 3 having a uniform thickness of 0.55 mm, a lower layer 2 having a uniform thickness of 0.30 mm, an intermediate fabric reinforcement layer 4 having a uniform thickness of 0.45 mm, a first adhesive layer 5 for fixing the intermediate layer 4 to the upper layer 3, and a second adhesive layer 6 for fixing the intermediate layer 4 to the lower layer 2.

The lower expanded elastomeric layer 2 of the rubber blanket 1 employed in the above-described solutions has the mechanical characteristics shown in the following table.

| | | Compressibility: | Load at | Pore |
|---|---|---|---|---|
| | thickness | deformation at 1.20 MPa | 150 μm | diameter |
| blanket | (mm) | (μm) | (MPa) | (μm) |
| FIG. 1 | 0.5 | 105 | 2.08 | 40-100 |
| and 2 | | | | |
| FIG. 3 | 0.3 | 91 | 2.93 | 40-120 |

Where the compressibility test measures the deformation by compression of the layer subjected to a fixed pressure (normal force per surface unit), whilst the load test measures the load that is necessary (normal force per surface unit) to obtain a fixed deformation (150 microns) under compression.

In general, it has been found to be advantageous to use a lower layer 2 having a deformation at 120 MPa comprised between 80 and 120 microns and a load comprised between 2 and 3 MPa to obtain a deformation of 150 microns.

A rubber blanket with the above-described structure, due to the fact that it comprises a lower layer made of an expanded elastomeric material with an adapted porosity, enables both a high grip to be obtained on the printing cylinder without using adhesives and grinding to be performed to bring the overall thickness of the rubber blanket to the desired value by abrasion of the contact surface of the lower layer without touching the printing surface of the upper layer which has the mirror finish.

The printing rubber blanket thus conceived is susceptible to various modifications and variants, all falling within the concept of the invention; moreover, all of the details can be replaced with other technically equivalent elements. In practice, the materials used, as well as the dimensions, can vary according to requirements and the state of the art.

1. A rubber blanket for a printing cylinder of a printing machine, comprising at least an upper printing layer made of compact elastomeric material, at least a lower layer having a contact surface in contact with said printing cylinder, and at least one fabric reinforcement layer interposed between the upper layer and the lower layer, wherein said lower layer is made of expanded elastomeric material.

2. The rubber blanket according to claim 1, wherein said layers are permanently connected to each other.

3. The rubber blanket according to claim 1, wherein said expanded elastomeric material has a porosity imparting to the lower layer a susceptibility to abrasion for rectifying the thickness of said lower layer.

4. The rubber blanket according to claim 1, wherein said expanded elastomeric material has a porosity imparting to the lower layer a susceptibility to direct adhesion to said cylinder without the addition of another adhesive layer.

5. The rubber blanket according to claim 1, wherein said expanded elastomeric material is a thermoplastic elastomer.

6. The rubber blanket according to claim 5, wherein said thermoplastic elastomer comprises a thermoplastic polyurethane.

7. The rubber blanket according to claim 1, wherein said expanded elastomeric material is a vulcanized thermoset elastomer.

8. The rubber blanket according to claim 7, wherein said vulcanized thermoset elastomer comprises at least one selected from PU, NBR, EPDM, SBR and EPM.

9. The rubber blanket according to claim 1, further comprises a sole fabric reinforcement layer, a first adhesive layer for fixing said intermediate layer to said upper layer, and a second adhesive layer for fixing said intermediate layer to said lower layer.

10. The rubber blanket according to claim 7, wherein said intermediate layer is at least partially formed from cotton fabric.

11. The rubber blanket according to claim 1, further comprises an intermediate fabric reinforcement layer having a thickness of 0.45 mm, a first adhesive layer for fixing said intermediate layer to said upper layer, a second adhesive layer for fixing said intermediate layer to said lower layer, a lower layer having a thickness of 0.50 mm, and a series of two upper layers each having a thickness of 0.35 mm.

12. The rubber blanket according to claim 1, further comprising an intermediate fabric reinforcement layer having a thickness of 0.45 mm, a first adhesive layer for fixing said intermediate layer to said upper layer, a second adhesive layer for fixing said intermediate layer to said lower layer, a lower layer having a thickness of 0.50 mm, and an upper layer having a thickness of 0.35 mm.

13. The rubber blanket according to claim 1, further comprising an intermediate fabric reinforcement layer having a thickness of 0.45 mm, a first adhesive layer for fixing said intermediate layer to said upper layer, a second adhesive layer for fixing said intermediate layer to said lower layer, a lower layer having a thickness of 0.30 mm, and an upper layer having a thickness of 0.55 mm.

14. A printing cylinder on which the rubber blanket according to any preceding claim is mounted, said contact surface of said lower layer being directly in contact with said cylinder without any interposition of adhesive.
